(19) United States
(12) Patent Application Publication
(10) Pub. No.: US 2002/0192524 A1
(43) Pub. Date: Dec. 19, 2002

(54) Fuel cell

(76) Inventors: Michael Bruder, Hamburg (DE); Uwe Heiber, Erfurt (DE); Karl-Heinz Krause, Chemnitz (DE); Gerhard Merkmann, Gotha (DE)

Correspondence Address: WILLIAM COLLARD, COLLARD & ROE, P.C., 1077 NORTHERN BOULEVARD, ROSLYN, NY, 11576, US

(21) Appl. No.: 10/149,955

(22) PCT Filed: Sep. 27, 2001
(86) PCT No.: PCT/DE01/03718

(30) Foreign Application Priority Data
Oct. 19, 2000 (DE) 100 52 113.4

(51) Int. Cl. H01M 8/10; H01M 8/08

(52) U.S. Cl. 429/33; 429/46

(57) ABSTRACT

The invention relates to a fuel cell (1), comprising at least the following components: a proton-conducting polymer membrane (2) as the electrolyte; catalyst layers (3) covering the polymer membrane (2) on both sides; gas-permeable electrodes in the form of an anode (4) and a cathode (5), which lie adjacent to the surface of the catalyst layers (3) that faces outwards; electroconductive plates (6), which come into electroconductive contact with the electrodes in at short distances and which together with the electrodes, delimit channels carrying gas; and gas connections for supplying hydrogen (H₂) and for supplying oxygen (O₂). The inventive fuel cell (1) is characterized in that the polymer membrane (2) is a mixture based on a polymer blend containing at least one first polymer group A which is based on a halogenated and/or sulphonated polyalkene, and one second polymer group B which is based on a vulcanized rubber with a polar character.

The invention relates to a fuel cell comprising at least the following components:

a proton-conducting polymer membrane as the electrolyte.

catalyst layers covering the polymer membrane on both sides;

gas-permeable electrodes, which have the form of an anode and cathode and which bear against the outwardly directed surfaces of the catalyst layers;

electrically conductive plates, which are in electrically conductive contact with the electrodes at closely spaced intervals and together with the electrodes define gas-conveying channels; and

gas ports for supply of hydrogen on one side and oxygen on the other.

A fuel cell of the class in question is described in detail in, for example, the following documents, namely German Patent A 3640108, German Patent A 19544323, International Patent WO A 94/09519, U.S. Pat. No. 5,292,600 and in “Spektrum der Wissenschaft” [Science Spectrum] (July 1995), pages 92 to 98.

Fuel cells are electrochemical energy converters that are comparable with battery systems, which convert stored chemical energy to current. In contrast to modern conventional current generators, current generation in a fuel cell takes place without the circuitous route of heat generation.

The core piece of the fuel cell is the polymer membrane, which is permitted to be permeable only for hydrogen ions (protons). On one side hydrogen flows past catalysts (such as platinum catalysts), thus being split into protons and electrons, while air or pure oxygen flows past on the other side. The protons pass through the polymer membrane and, together with the electrons functioning as the effective current, combine with oxygen to form water, which remains as the single waste product. Thus the hydrogen liberates electrons at one electrode and oxygen absorbs them at the other electrode.

At present, plastic membranes are used in fuel cells. The materials used for this purpose are in particular polysulfones (German Patent A 19809119), thermoplastic polyether ketones and polytetrafluoroethylene with sulfonic perfluorovinyl ether side chains (Nafion 117 of du Pont).

Despite various proposed solutions, the proton conductivity of polymer membranes heretofore has left much to be desired, both from technical and from economic viewpoints. It is therefore understandable that considerable research is being done on polymer membranes, especially in materials technology.

By means of the inventive fuel cell, in which there is used a polymer membrane in the form of a mixture based on a polymer blend, which in turn comprises at least

a first polymer group A based on a halogenated and/or sulfonated polyalkene, as well as

a second polymer group B based on a vulcanized rubber having polar character, there is achieved a new direction with regard to materials, in combination with highly efficient proton conductivity accompanied simultaneously by technically simpler and more cost-effective manufacture.

The two polymer groups A and B will be explained in more detail hereinafter.

Polymer Group A

As regards the halogenated polyalkene, the halogen basis is fluorine, chlorine or bromine.

The sulfonated polyalkene also comprises sulfonic acid derivatives, in the form, for example, of a chlorosulfonated polyalkene.

Of special importance within this polymer group is halogenated and/or sulfonated polyethylene.

The content of polymer group A is ≧ the content of polymer group B. In this connection the content of polymer group A in the mixture is 40 to 80 wt %, preferably 45 to 60 wt %.

Polymer group A is in particular a thermoplastic. Thus the group of materials comprising the thermoplastic elastomers (abbreviated TPE) can be used in the blend with polymer group B as a vulcanized product.

Polymer Group B

The following types of rubber in particular are used in a proportion of at least 10 wt % in the mixture:

fluorinated rubber (abbreviated FKM)

chloroprene rubber (2-chloro-1,3-butadiene; abbreviated CR)

chlorobutyl rubber (abbreviated CIIR)

bromobutyl rubber (abbreviated BIIR)

nitrile rubber (abbreviated NBR)

acrylate rubber (abbreviated ACM)

Advantageously the mixture contains a molecular sieve with high content of water of crystallization and, in fact, at least 100 moles of water of crystallization. In this connection, the sodium aluminosilicate of the following formula is worth particular mention:

Na₈₆[(AlO₂)₈₆ .(SiO₂)₁₀₆].276H₂O

Furthermore, it is advantageous for the molecular sieve to be loaded with an acid while achieving partial dehydration, specifically by forming a molecular sieve/acid adduct. Thus part of the water of crystallization is removed and replaced by an acid. The degree of loading with acid amounts to 5% to 30%, preferably 15%. In this way the proton conductivity of the polymer membrane is increased.

Alternatively, but especially in combination with a molecular sieve/acid adduct, even silica gel can be added as acid catalyst to the mixture.

In another alternative, but especially in combination with a molecular sieve/acid adduct and silica gel, there can be further added to the mixture a fiber, especially a cellulose fiber, this fiber being loaded with acid, especially by formation of a fiber/acid adduct. The degree of loading with acid amounts to 5% to 30%, preferably 15% in this case also. In this way both the proton conductivity and the mechanical stability (tearing and structural strength) are improved.

Furthermore, it is advantageous when there is further added to the mixture a reinforcing resin, especially in combination with a hardening agent. The reinforcing resin/hardening agent system will now be discussed in more detail.

Reinforcing resins are raw materials composed on the basis of substituted phenols and formaldehyde. In the initial condition they are non-cross-linked and thermoplastic substances, which are added to the mixture and then transformed at higher temperatures (≧130° C.) to cross-linked structures by a hardening agent (such as hexamethoxymethylamine), which is also added. Following addition of the hardener, the reinforcing resin reacts with itself, but not with the rubber. Thus two mutually independent cross-linking reactions take place. The characteristics of the material can be improved particularly significantly by use of the reinforcing resin/hardening agent system, specifically from the following viewpoints:

increase of structural strength

increase of fatigue resistance/endurance limit/service life

reduction of abrasive wear

Examples of further standard mixture ingredients are sulfur or sulfur donors, accelerators, metal oxide (such as MgO, ZnO), fillers and anti-aging substances.

Because of the fact that the reinforcing resin/hardening agent system as well as the fiber/acid adduct contributes to increasing the mechanical stability of the polymer membranes, it is usually possible to dispense with an additional reinforcing structure in the form of a fabric.

If necessary, the polymer membrane is fabric-reinforced, especially on the basis of polyamide (such as polyamide 6.6).

Furthermore, the polymer membrane advantageously has a layer thickness of 0.05 mm to 1 mm, especially 0.1 to 0.2 mm.

For evaluation of the mixture with regard to its electrical (electronic, protonic) behavior, the following requirements must be met:

The specific electronic volume resistance σₑ₋ must be very much greater than the specific protonic volume resistance σₚ₊, and the ratio of the two relative to one another is proportional to the efficiency W of the fuel cell, specifically from the viewpoint that W˜σₑ₋/σₚ₊.

Protonic conductivity, defined by 1/σₚ₊, requires the presence of protons in the polymer membrane.

A specific electronic volume resistance σₑ₋ is contingent upon the absence of free charge carriers (electrons, vacancies).

Capacitive and inductive effects can be disregarded within the following working range:

operating temperature T: −40° C. ≦T ≦150° C.

pressure p: 0.9 at ≦p ≦3 at

D.C. voltage U: |U| ≦10 V

The polymer membrane can be used for a low-temperature fuel cell (operating temperature <100° C.).

The invention will now be explained on the basis of schematic diagrams, wherein:

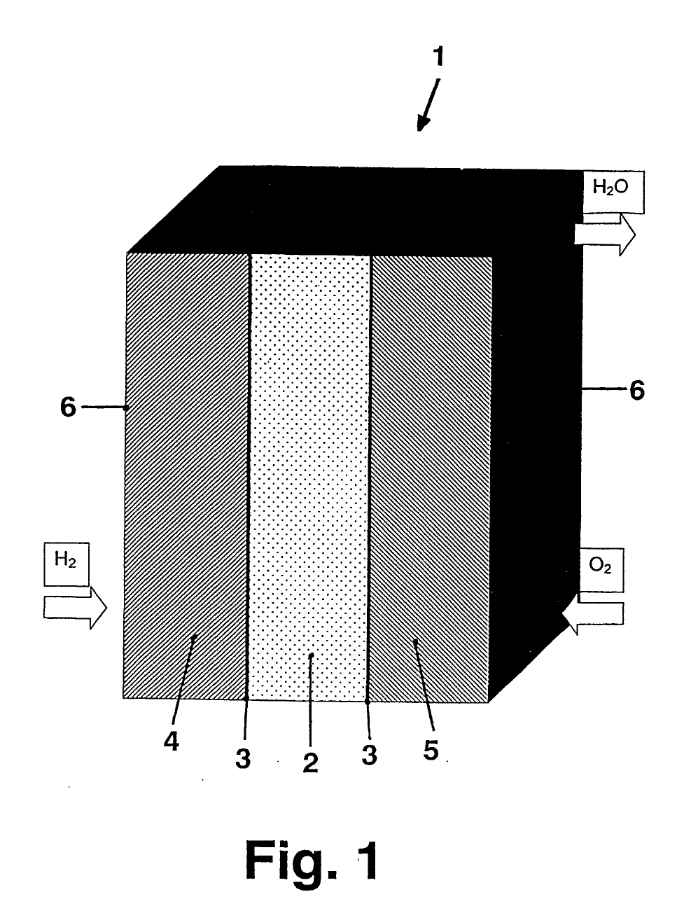

FIG. 1 shows a fuel cell;

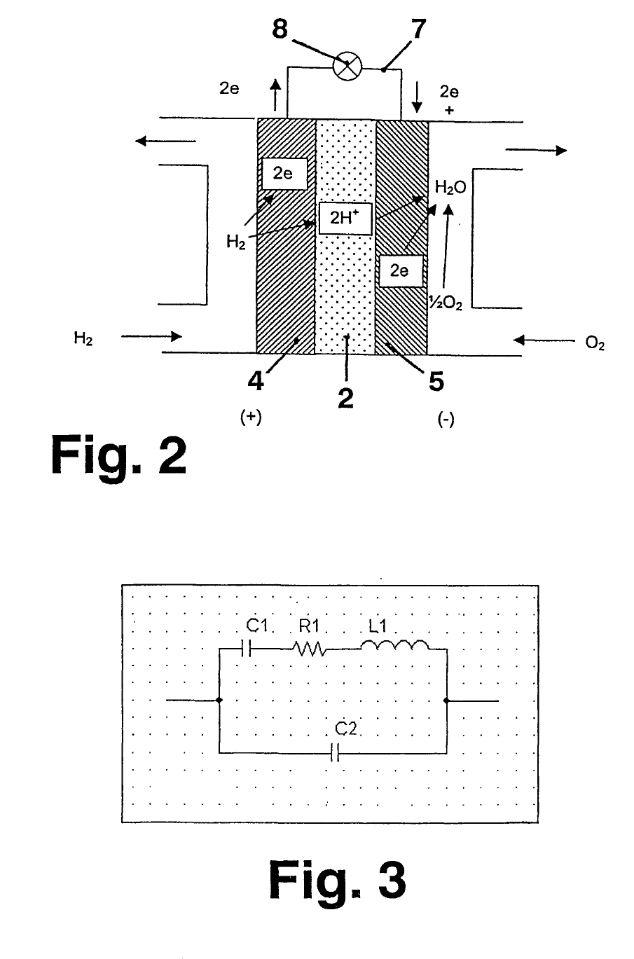

FIG. 2 shows the sequence of electrochemical reactions in a fuel cell;

FIG. 3 shows an electrical description of the mixture.

According to FIG. 1, fuel cell 1 contains a proton-conducting polymer membrane 2 as electrolyte, specifically in the form of a mixture based on a polymer blend comprising the two polymer groups A and B. This polymer membrane 2 is covered on both sides by catalyst layers 3. Against the outwardly directed surfaces of catalyst layers 3 there bear gas-permeable electrodes in the form of an anode 4 and cathode 5. Electrically conductive plates 6 bound the fuel cell on the anode and cathode sides and form a structural unit together with the gas-permeable electrodes. Gas ports for hydrogen (H₂) and oxygen (O₂) are also provided.

A plurality of individual cells 1 can now be interconnected as cell piles, wherein the polymer membrane with a layer thickness of 0.05 to 1 mm, especially 0.1 to 0.2 mm, contributes to a relatively small overall installation space.

FIG. 2 shows the sequence of electrochemical reactions of a fuel cell with the following steps:

a first individual reaction at anode 4 (H₂→2H⁺+2 e);

proton migration through polymer membrane 2;

electron flow via an external circuit 7, which is connected. to an electrical load 8;

second individual reaction at cathode 5 (2H⁺+2 e +½O₂ →H₂O).

Since it would be too costly to replace the existing network of gasoline service stations by a hydrogen network, the direction taken by development is to generate hydrogen directly on board the automobile, preferably from methanol, which can be easily obtained from natural gas or from regenerable raw materials and, in common with gasoline, can be filled into fuel tanks. For this purpose a reforming reactor is necessary as a small chemical system. Furthermore, the direct methanol fuel cell with internal reformer using a reformer layer is known (German Patent A 19945667).

Air is usually sufficient as the oxygen source.

Furthermore, the water formed ensures that the water of crystallization of the molecular sieve is not consumed.

FIG. 3 shows an electrical description of the mixture. Therein C1 and C2 are capacitive elements, L1 is an inductance and R1 is the internal resistance of the mixture or polymer membrane 2 (FIGS. 1 and 2) which is of interest as regards application.

List of reference symbols

| | |
|---|---|
| 1 | Fuel cell (individual cell) |
| 2 | Proton-conducting polymer membrane |
| 3 | Catalyst layer |
| 4 | Electrode (anode) |
| 5 | Electrode (cathode) |
| 6 | Electrically conductive plate (bipolar plate) |
| 7 | External circuit |
| 8 | Electrical load |

1. A fuel cell (1) comprising at least the following components:
a proton-conducting polymer membrane (2) as the electrolyte.
catalyst layers (3) covering the polymer membrane (2) on both sides;
gas-permeable electrodes, which have the form of an anode (4) and cathode (5) and which bear against the outwardly directed surfaces of the catalyst layers (3);
electrically conductive plates (6), which are in electrically conductive contact with the electrodes at closely spaced intervals and together with the electrodes define gas-conveying channels; and
gas ports for supply of hydrogen on one side and oxygen on the other;
characterized in that the polymer membrane (2) is a mixture based on a polymer blend, which in turn comprises at least
a first polymer group A based on a halogenated and/or sulfonated polyalkene, as well as
a second polymer group B based on a vulcanized rubber having polar character,

2. A fuel cell according to claim 1, characterized in that first polymer group A is a halogenated and/or sulfonated polyethylene.

3. A fuel cell according to claim 1 or 2, characterized in that there is used a halogenated polyalkene/polyethylene based on fluorine, chlorine or bromine.

4. A fuel cell according to one of claims 1 to 3, characterized in that the first polymer group A is a thermoplastic.

5. A fuel cell according to one of claims 1 to 4, characterized in that the second polymer group B is a halogenated rubber based on fluorine, chlorine or bromine.

6. A fuel cell according to claim 5, characterized in that there is used fluorinated rubber, chloroprene rubber, chlorobutyl rubber or, in particular, bromobutyl rubber.

7. A fuel cell according to one of claims 1 to 4, characterized in that the second polymer group B is nitrile rubber.

8. A fuel cell according to one of claims 1 to 4, characterized in that the second polymer group B is acrylate rubber.

9. A fuel cell according to one of claims 1 to 8, characterized in that the content of the first polymer group A≧the content of the second polymer group B.

10. A fuel cell according to one of claims 1 to 9, characterized in that the content of the first polymer group A in the mixture is 40 to 80 wt %, preferably 45 to 60 wt %, while the second polymer group B has a content of at least 10 wt %.

11. A fuel cell according to one of claims 1 to 10, characterized in that the mixture contains a molecular sieve with high content of water of crystallization.

12. A fuel cell according to claim 11, characterized in that the molecular sieve is a metal aluminosilicate with the following formula:
Meₙ[(AlO₂)ₓ.(SiO₂)_{y}].mH₂O

13. A fuel cell according to claim 12, characterized in that there is used a metal (Me) of the first or second group of the periodic table, preferably sodium.

14. A fuel cell according to claim 12 or 13, characterized in that the molecular sieve is a sodium aluminosilicate with the following formula:
Na₈₆[(AlO₂)₈₆.(SiO₂)₁₀₆].mH₂O

15. A fuel cell according to one of claims 11 to 14, characterized in that the molecular sieve contains at least 100 moles (m), preferably at least 200 moles (m) of water of crystallization.

16.A fuel cell according to claim 15, characterized in that the molecular sieve contains 276 moles (m) of water of crystallization.

17. A fuel cell according to claim 14 and 16, characterized in that the molecular sieve is a sodium aluminosilicate with the following formula:
Na₈₆[(AlO₂)₈₆.(SiO₂)₁₀₆].276H₂O

18. A fuel cell according to one of claims 11 to 17, characterized in that the molecular sieve is loaded with an acid while achieving partial dehydration, specifically by forming a molecular sieve/acid adduct.

19. A fuel cell according to claim 18, characterized in that the adduct contains a hydracid and/or an oxy acid.

20. A fuel cell according to claim 19, characterized in that the adduct contains an aqueous hydracid.

21. A fuel cell according to claim 19, characterized in that the adduct contains an aqueous oxy acid.

22. A fuel cell according to claim 20 or 21, characterized in that the acid solution is 0.1 to 5 molar.

23. A fuel cell according to one of claims 18 to 22, characterized in that the degree of loading with the acid is 5% to 30%, preferably 15%.

24. A fuel cell according to one of claims 1 to 23, especially in combination with one of claims 11 to 23, characterized in that the mixture contains silica gel.

25. A fuel cell according to one of claims 1 to 24, especially in combination with one of claims 11 to 24, characterized in that the mixture contains a fiber, which is loaded with an acid, especially by formation of a fiber/acid adduct.

26. A fuel cell according to claim 25, characterized in that there is used a cellulose fiber loaded with acid.

27. A fuel cell according to claim 25 or 26, characterized in that the fiber is loaded with phosphoric acid, preferably in concentrated form.

28. A fuel cell according to one of claims 25 to 27, characterized in that the degree of loading with the acid is 5% to 30%, preferably 15%.

29. A fuel cell according to one of claims 1 to 28, especially in combination with one of claims 11 to 28, characterized in that the mixture contains a reinforcing resin, preferably with addition of a hardening agent.

30. A fuel cell according to one of claims 1 to 29, characterized in that the polymer membrane (2) is fabric-free.

31. A fuel cell according to one of claims 1 to 29, characterized in that the polymer membrane (2) is fabric-reinforced.

32. A fuel cell according to claim 31, characterized in that the fabric is made on the basis of polyamide, such as polyamide 6.6.

33. A fuel cell according to one of claims 1 to 32, characterized in that polymer membrane (2) has a layer thickness of 0.05 to 1 mm, preferably 0.1 mm to 0.2 mm.

34. A fuel cell according to one of claims 1 to 33, characterized in that, as regards the specific electronic volume resistance σₑ₋, the specific protonic volume resistance σₚ₊, the density ρ and the structural strength SF of the mixture, the following parameters are applicable:
σₑ₋≧10⁶ Ωcm
σₚ₊≦200 Ωcm
1.2 g/cm³≦ρ≦1.5 g/cm³
SF≧15 N/mm

35. A fuel cell according to one of claims 1 to 34, characterized in that it is used as a low-temperature fuel cell.
